(19) United States
(12) Patent Application Publication
(10) Pub. No.: US 2023/0194085 A1
(43) Pub. Date: Jun. 22, 2023

(54) APPARATUS FOR CAPTURING COMBUSTION PRODUCTS AND METHOD

(71) Applicant: 4 SYMBIOSES INC., Rivière-du-Loup (CA)

(72) Inventors: Gérald PELLETIER, Lac Baker (CA); Jean DESPRÉS, St-Antonin (CA)

(21) Appl. No.: 17/998,858

(22) PCT Filed: May 14, 2021
(86) PCT No.: PCT/CA2021/050662

§ 371 Date: Nov. 15, 2022

Related U.S. Application Data
(60) Provisional application No. 63/025,500, filed on May 15, 2020.

(51) Int. Cl. F23J 15/04; B01D 47/06

(52) U.S. Cl. CPC F23J 15/04; B01D 47/06; F23J 2215/00

(57) ABSTRACT

An apparatus for capturing combustion gases includes a container defining an inner cavity configured for holding a liquid, and an exhaust end for exhausting gas. An inlet is in fluid communication with a lower portion of the inner cavity, and adapted to receive an injection of combustion gases. One or more fragmentation members are located in the inner cavity downstream of the inlet and upstream of the exhaust end, the fragmentation member configured to be immersed in the liquid of the container, to induce a fragmentation of the combustion gases passing therethough for capture of the combustion gases by the liquid. A method for capturing combustion gases in a liquid is provided.

### CROSS-REFERENCE TO RELATED APPLICATION

The present application claims the priority of U.S. Patent Application No. 63/025,500, filed on May 15, 2021 and incorporated herein by reference.

### TECHNICAL FIELD

The present disclosure pertains to the capture of pollutants, such as combustion products (also known as by-products), and to an apparatus and method to achieve such capture.

### BACKGROUND

Combustion is commonly used in various industries, commercially, institutionally, to produce energy for processes, for transformations, and/or for any other uses. Combustion may occur in various apparatuses, including ovens, furnaces, boilers, burners, etc. A known downside of combustion is the generation of the combustion products. Combustion products may include carbon dioxide, water and other constituants such as carbon monoxide and/or other pollutants as a function of the fuel being burned. Moreover, combustion products may be toxic and may typically be at high temperatures. As a result, combustion products are conventionally exhausted to the atmosphere.

With increasing regulations regarding the environment and constraints such as carbon tax, it is desired for operators of combustion equipment to reduce their environmental footprint. It is therefore desirable to reduce emissions made to the environment, notably by capturing some combustion products and reclaiming energy losses.

### SUMMARY

In a first aspect, there is provided an apparatus for capturing combustion gases comprising: a container defining an inner cavity configured for holding a liquid, and an exhaust end for exhausting gas; an inlet in fluid communication with a lower portion of the inner cavity, and adapted to receive an injection of combustion gases; at least one fragmentation member located in the inner cavity downstream of the inlet and upstream of the exhaust end, the fragmentation member configured to be immersed in the liquid of the container, to induce a fragmentation of the combustion gases passing therethough for capture of the combustion gases by the liquid.

Still further in accordance with the first aspect, for example,

2. The apparatus according to claim 1, wherein a plurality of the fragmentation member are located one on top of another.

Still further in accordance with the first aspect, for example, the at least one fragmentation member is a plate with holes.

Still further in accordance with the first aspect, for example, the holes have a surface ranging between 0.0122 in² and 0.790 in², inclusively.

Still further in accordance with the first aspect, for example, the holes have a surface of at most 3.14 in².

Still further in accordance with the first aspect, for example, the plates are separated from an inner wall defining the inner cavity by an annular gap.

Still further in accordance with the first aspect, for example, heat exchanger pipes are in the annular gap.

Still further in accordance with the first aspect, for example, deflector rings are in the annular gap, between the heat exchanger pipes and the inner wall.

Still further in accordance with the first aspect, for example, rims interface the heat exchange pipes to the deflector rings.

Still further in accordance with the first aspect, for example, the deflector rings are axially offset from the plates in a vertical direction.

Still further in accordance with the first aspect, for example, a structure interconnects the plates, the structure and the plates being removable from the container as an assembly.

Still further in accordance with the first aspect, for example, a heat exchange system is connected to the container for heat exchange between a heat-transfer fluid in the heat exchange system and the liquid in the container.

Still further in accordance with the first aspect, for example, the heat exchange system includes an annular chamber surrounding the container.

Still further in accordance with the first aspect, for example, the heat exchange system includes heat exchanger pipes extending into the inner cavity.

Still further in accordance with the first aspect, for example, the container is an upstanding elongated container.

Still further in accordance with the first aspect, for example, the upstanding elongated container is a cylindrical container.

Still further in accordance with the first aspect, for example, the upstanding elongated container is open ended.

Still further in accordance with the first aspect, for example, a cover is on a top of the upstanding elongated container.

Still further in accordance with the first aspect, for example, a fan assembly is located on the cover and is configured to cause a negative pressure differential at a top of a liquid line in the container.

Still further in accordance with the first aspect, for example, a shield is between the fan assembly and the inner cavity.

Still further in accordance with the first aspect, for example, the shield is an inverted cone.

Still further in accordance with the first aspect, for example, a liquid level controller device monitors a level of liquid in the apparatus.

Still further in accordance with the first aspect, for example, the liquid level controller device is connected to liquid inlet and outlet of the container to adjust a level of the liquid in the container.

In accordance with a second aspect, there is provided a method for capturing combustion gases in a liquid comprising: injecting combustion gases in a liquid in a container; inducing a fragmentation of the combustion by passing through at least one fragmentation member to capture of the combustion gases by the liquid; and discharging the liquid having captured the combustion gases.

Still further in accordance with the second aspect, for example, inducing the fragmentation of the combustion includes causing a pressure differential at a top of a liquid line in the container.

Still further in accordance with the second aspect, for example, heat is recuperated from the liquid by heat exchange with a heat-transfer fluid.

Still further in accordance with the second aspect, for example, a viscous substance settled from the liquid is collected.

Still further in accordance with the second aspect, for example, a level of liquid in the container is monitored.

Still further in accordance with the second aspect, for example, injecting or removing liquid as a function of the monitoring is performed.

In accordance with a third aspect, there is provided an apparatus for capturing pollutants in a gas comprising: a container defining an inner cavity configured for holding a liquid, and an exhaust end for exhausting gas; an inlet in fluid communication with a lower portion of the inner cavity, and adapted to receive an injection of a gas; at least one fragmentation member located in the inner cavity downstream of the inlet and upstream of the exhaust end, the fragmentation member configured to be immersed in the liquid of the container, to induce a fragmentation of the gas passing therethough for capture of the pollutants in the gas by the liquid.

### DESCRIPTION OF THE DRAWINGS

Reference is now made to the accompanying figures in which:

FIG. 1 is a perspective sectioned view of an apparatus for capturing combustion products in accordance with the present disclosure;

FIG. 2 is a side elevation sectioned view of the apparatus of FIG. 1;

FIG. 3 is another perspective sectioned view of the apparatus of FIG. 1;

FIG. 4 is an enlarged perspective view of a junction between a fragmenting assembly and a container of the apparatus of FIG. 1;

FIG. 5 is an enlarged perspective view of a fan assembly of the apparatus of FIG. 1;

FIG. 6 is an enlarged sectioned view of a junction between a heat exchanger system and a container of the apparatus of FIG. 1;

FIG. 7 is an enlarged perspective view of a fragmenting member and deflector ring of the apparatus of FIG. 1;

FIG. 8 is another enlarged perspective view of a fragmenting member and deflector ring of the apparatus of FIG. 1;

FIG. 9 is a perspective view of a liquid level controller device of the apparatus of FIG. 1; and

FIG. 10 is an elevation cutaway view of the liquid level controller device of FIG. 9.

### DETAILED DESCRIPTION

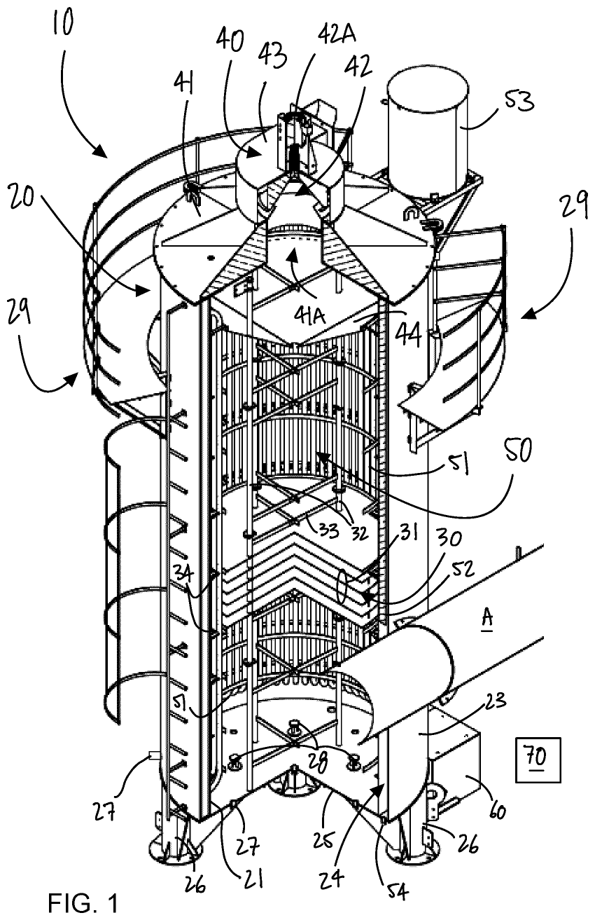

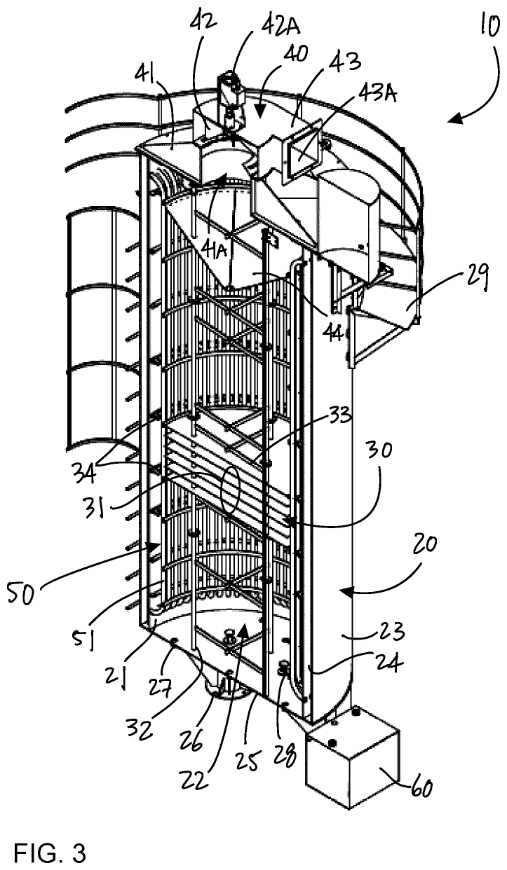

Referring to the drawings and more particularly to FIGS. 1 to 3, an apparatus for capturing combustion products (i.e., gases, vapour, airborne particles) or other pollutants (e.g., dust) in accordance with the present disclosure is generally shown as 10. The apparatus 10 is shown in combination with a chimney A that exhausts combustion gases to be treated by the apparatus 10. The chimney A may be at the exhaust of equipment performing combustion, such as an oven, a furnace, a boiler, a burner, a turbine, etc. The chimney A is shown as descending toward the apparatus 10, but other chimney orientations are contemplated. For example, the apparatus 10 may be mounted to a top of a chimney A as one possibility. Moreover, while the expression chimney is used, other types of conduits may be used to direct combustion products to the apparatus 10. Moreover, the apparatus 10 may be used as a filter for ventilation systems, whereby the chimney shown at A could be a ventilation conduit A as well. For simplicity, reference is made herein to the capture of combustion products, based on the use of the apparatus 10 downstream of a combustion process. However, if the apparatus 10 is used for other applications, it may capture pollutants other than combustion products. The use of the expression “combustion products” does not entail that the apparatus 10 is used strictly for the capture of combustion products. The apparatus 10 may be directly at a burner or furnace, and thus without chimney.

The apparatus 10 may have various components and/or sub-components such as a container 20, a fragmenting assembly 30, a fan assembly 40, a heat exchanger system 50, a collection basin 60 and/or a controller 70.
The container 20 forms the body of the apparatus 10 and supports various components thereof. The container 20 may be known as a structure, water tower, tower, tank, receiver, reservoir, reactor, etc. The container 20 holds the liquid (e.g., water, oil) that is used in capturing combustion products, and therefore forms the structure of the apparatus 10;
The fragmenting assembly 30 is tasked with ensuring that combustion gases are in a proper condition to mix with and get captured by liquid inside the apparatus 10;
The fan assembly 40 induces a flow of air/gases out of the apparatus 10 so as to assist in the capturing;
The heat exchanger system 50 recuperates/reclaims heat from the combustion for other uses;
The collection basin 60 is one possible component for collecting solid or viscous waste from the apparatus 10; and/or The controller 70 may optionally be present, and may include a processor unit(s) and a non-transitory computer-readable memory communicatively coupled to the processing unit and having computer-readable program instructions executable by the processing unit for performing functions related to the apparatus 10.

Still referring to FIGS. 1 to 3, the container 20 is shown having an inner wall 21. For simplicity, the expression “container 20” is used herein, though the container 20 could also be referred to in other ways, such as structure, water tower, tower, tank, receiver, reservoir, reactor, etc. The inner wall 21 may be an upstanding tubular container. For example, the inner wall 21 may be an upstanding cylinder. The expression “upstanding” entails that a central axis of the tubular inner wall 21 is generally vertical. Other orientations are contemplated. The inner wall 21, in its tubular assembly of circular, square, oval cross-section as possibilities, defines an inner cavity 22 of the apparatus 10. As observed, the inner wall 21 may be elongated, i.e., have a length along its central axis that is more than its diameter (e.g., by at least 1.5 times). The inner cavity 22 receives a liquid such as water, with the water being the capture medium. Accordingly, the water may be known as grey water or waste water, and may include chemicals to control its characteristics. Other liquids may be used, such as oil. In the illustrated embodiment, the chimney A is connected to the inner wall 21 so as to be in fluid communication with the inner cavity 22 such that combustion gases are directed into the inner cavity 22. The connection of the chimney A to the inner wall 21 is at a lower portion of the container 20. The inner cavity 22 may be round as observed in the figures and hence the expression diameter is well suited to describe the dimension of the inner cavity 22, but other shapes are considered, as suggested above. The inner cavity 22 may for instance have a diameter range from 24 in to 20 ft, though it may be larger as well. However, the cross-section can have other shapes (e.g., square. oval, etc), and hence the expression “largest diametrical dimension” or “largest opening dimension” could apply to the cavity 22, with such dimensions also ranging from 24 in to 20 ft, inclusively, though the dimension could be outside of such range. The diameter may be selected as a function of the volumetric flow of combustion gases to be treated by the apparatus 10. In an embodiment, a plurality of the apparatus 10 may be used for a single source of combustion, with the apparatuses 10 being for example in a parallel set up, for instance via numerous chimneys A.

An outer wall 23 may surround the inner wall 21. The outer wall 23 may emulate the shape of the inner wall 21. For example, the inner wall 21 and the outer wall 23 are concentric, and may have similar cross-sectional shapes (e.g., circle). A chamber 24 is consequently defined between the inner wall 21 and the outer wall 23. The chamber 24 may be annular and is dependent on the shapes of the inner wall 21 and outer wall 23. The annular chamber 24 has a thickness that is for instance at least 10 times less than a diameter of the inner cavity 22. The annular chamber 24 may be isolated from the inner cavity 22, in that liquid does not flow from one to the other.

A bottom wall, such as a bottom plate 25, may be provided at a bottom of the container 20 so as to close off the inner cavity 22. The bottom plate 25 is shown as being planar. It is contemplated to provide other shapes to the bottom plate 25, such as a concave or convex surface. For example, the bottom plate 25 may be an inverted cone so as to force viscous waste to be directed to a central portion of the bottom plate 25. Other geometries are contemplated.

In an embodiment, the inner wall 21, the outer wall 22 and the bottom plate 25 are made of metal or like material combining structural integrity and heat transfer capability. The container 20 is designed to contain a liquid and must be exposed to high temperatures due to the injection therein of combustion gases, whereby its material must have the capacity of withstanding high process temperatures.

Legs 26 may be provided at the bottom of the container 20 and interfaced to a ground or container. The legs 26 are one option among others to support the container 20 in a self-standing configuration as shown. In another embodiment, the container 20 is mounted directly to the ground, may be supported by structural arms on its sides, may be supported by a chimney A, among other possibilities.

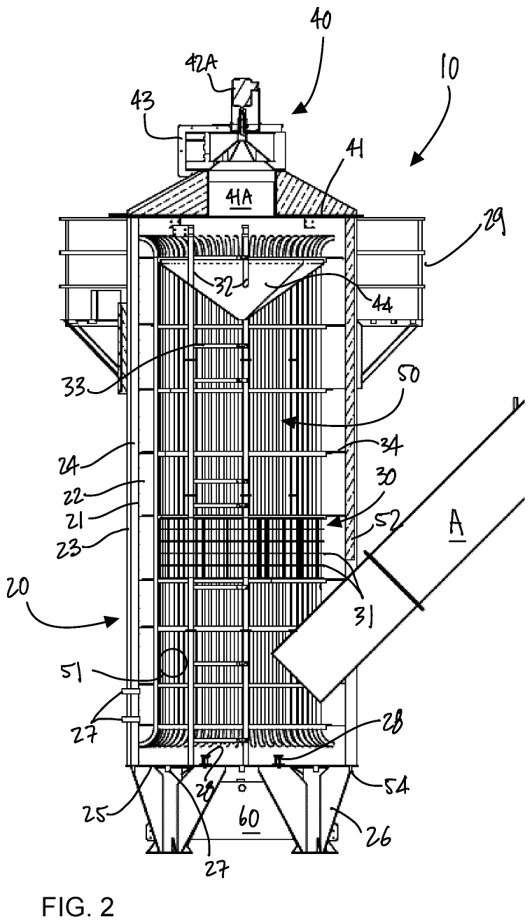

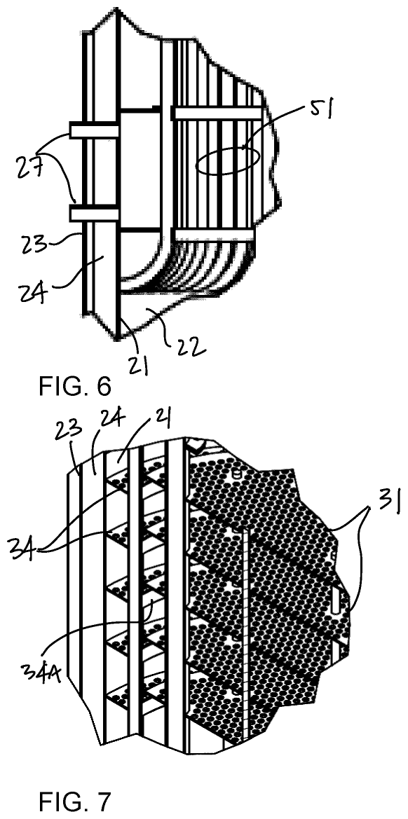

As observed from FIGS. 2 and 6, one or more outlets 27 may extend from the inner cavity 22, through the annular chamber 24 to an exterior of the outer wall 23. The outlets 27 may be tubes by which liquid or viscous substance that is inside the inner cavity 22 may be expelled. Such outlet(s) 27 may be provided at various locations along the container 20, including in the bottom plate 25, for removal of viscous substances. The outlet(s) 27 may be distanced from a plane of the bottom plate 25, so as to generally be above a level of viscous waste that may accumulate in the bottom of the inner cavity 22. Although not shown, valves may be present to close off the outlets 27 so as to control the outflow of liquid from the interior of the inner cavity 22. For instance, the outlets 27 may be connected a pipe network that would include such valves, even though such valves may also be an integral part of the apparatus 10.

Sprinklers 28 may be provided within the inner cavity 22. According to an embodiment, the sprinklers 28 are on the bottom plate 25. Other locations may include the connection of such sprinklers 28 to the inner wall 21. The sprinklers 28 are one of numerous components that may be used to cause a movement of the liquid in the bottom of the inner cavity 22. In an embodiment, the sprinklers 28 inject liquid, such as clean water, to cause a movement of the viscous substance in the bottom of the inner cavity 22. As an alternative to sprinklers 28, one or more of a jet(s), nozzle(s), impeller(s), etc. may be used to cause the movement in the bottom of the inner cavity 22. In an embodiment, the water input from the sprinklers 28 and output via the outlets 27 is controlled to ensure that the liquid contained in the container 20 has desired characteristics for the capture. An impeller could cause the mixing as well.

In order to access a top of the upstanding configuration of the container 20, there may be numerous maneuvering components, such as a ramp, a ladder, with appropriate safety components such as cages, fencing. All of these may be generically shown at 29. These components may be optional in that the apparatus 10 may be surrounded by appropriate building structures to access its various components. It is also contemplated to use movable equipment to access the apparatus 10, such as ladders, lifts, cranes, etc.

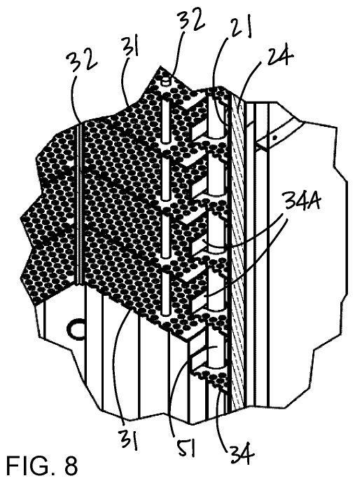

Referring to FIGS. 1 to 4, a fragmenting assembly 30 is shown. The expression “fragmenting assembly” is one among others that can be used to describe the assembly 30, others including mixing assembly, filtering assembly, etc. The fragmenting assembly 30 is tasked with ensuring that combustion gases injected into the liquid of the inner cavity 22 mix with the liquid. This may notably be achieved by slowing down the upward movement of the combustion gases and/or the fragmenting of the combustion gases into smaller bubbles. In an embodiment, the fragmenting assembly 30 includes one or more fragmenting members 31. In a further embodiment, the fragmenting members 31 are superposed one on top of the other and may be in the form of disks, screens, sieves, pierced plates, mesh, etc. that restrict passage of gases therethrough. For example, the discs shown in the figures may be used with other components, such as a steel wool, mesh filter, etc, between the discs. The diameter of the holes is between 0.125 inch to 1.0 inch to form numerous throats limiting the passage of gases through them, in accordance with an embodiment. The diameter of the holes may be less than 2.0 inch in another embodiment. It is also considered to have larger holes, but with more fragmenting members 31. The holes may be round as observed in FIGS. 7 and 8, and hence the expression diameter is well suited to describe the dimension of the holes. In some of the figures, the fragmenting members 31 are shown without holes for clarity of the figures. However, the holes can have other shapes (e.g., square. oval, etc), and hence the expression “largest diametrical dimension” or “largest opening dimension” could apply to the holes, with such dimensions also ranging from 0.125 inch to 1.0 inch, inclusively. It is contemplated to have holes outside of such range. In an embodiment, an area of the holes is between 0.0122 in² and 0.790 in², inclusively, or at most 3.14 in².

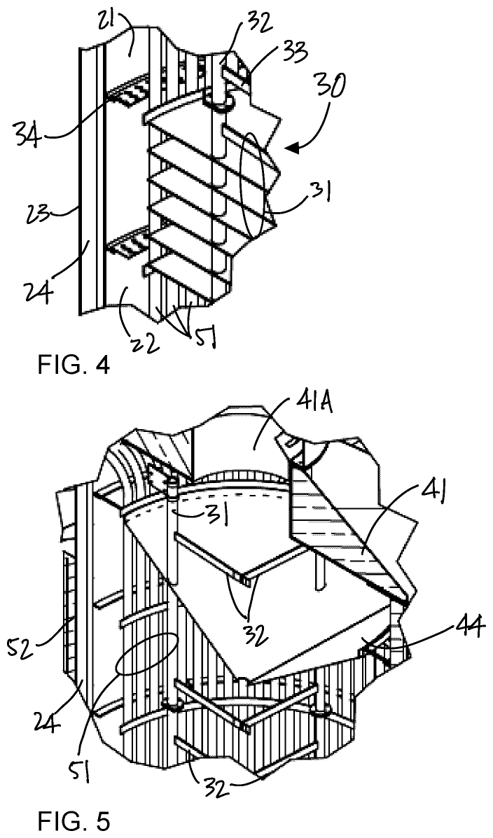

The fragmenting members 31 may be interconnected by support rods 32. Supports rods 32 may be vertical rods that may be used to interconnect the fragmenting assembly 30 to be pulled out of the inner cavity 22 from a top open end. In an embodiment, rings are positioned along the support rods 32, with the fragmenting members 31 resting on such rings. Spacer rods 33 may keep the support rods 32 spaced apart from one another and/or may be used to stiffen the assembly. Alternatively, the fragmenting members 31 may rest on shoulders on the inner wall 21, as a possibility among others. Referring to FIG. 4, in order to force the gases through the fragmenting members 31, deflector rings 34 may project inwardly from the inner wall 21 into the inner cavity 22 to block any gap between the members 31 and the wall 21. As alternatives to deflector rings 34, wipers may be used, as a possibility among others. As observed from FIGS. 7 and 8, the deflector rings 34 may have holes as well, with the holes being similar in dimensions and/or shape than those of the fragmenting members 31. In an embodiment, the deflector rings 34 are intercalated with the fragmenting members 31. It is contemplated to have the deflector rings 34 with holes in a hole density lower than a hole density of the fragmenting members 31 (e.g., fewer hole area per surface unit). This would allow flowthrough in the deflector rings 34, yet at a lesser flow rate than the flow through the fragmenting members 31. The deflector rings 34 promote fluid circulation around the heat exchange pipes 51 and hence a heat exchange. In an embodiment, the fragmenting members 31 extend all the way to the inner wall 21.

A rim 34A (FIGS. 7 and 8) may be at an end of one or more of the deflector rings 34. The rims 34A can be side walls or tubular walls or rings, and are in contact with the heat exchange pipes 51 to isolate the freedom of vibration of the pipes 51, and/or thermal expansion/contraction, from the deflector rims 34. The deflector rims 34 may have holes larger than a diameter of the pipes 51, and the rims 34A (or brackets, or the like) may be vertical and in contact with the pipes 51. A freedom of movement may be permitted between the rims 34A and the deflector rings 34 and/or the pipes 51, and/or the rims 34A may be elastic or deformable. The rims 34A may also be secured to the heat exchange pipes 51, and spot welding is an option considered to secure the rings 34 and/or rims 34A to the heat exchange pipes 51. Mechanical fasteners could also be used. In an embodiment, the fragmenting members 31 may also be movable (e.g., shakeable) to induce fragmentation. A plane of the fragmenting members 31 may be positioned such that a longitudinal axis of the container 20 is normal to the planes of the fragmenting members 31. A vector of movement of the gases, opposite gravity, may also be normal to a plante of the fragmenting members 31.

It may be desired to induce a flow of gas to ensure that combustion products injected into the fluid of the container 20 by the chimney A are convected upwardly. Therefore, a fan assembly 40 may be provided at a top of the container 20 and may generally seal it off to cause a negative pressure differential that may create a suction effect (i.e., a vacuum). The fan assembly 40 may consequently include a cover 41. The cover 41 may alternatively be part of the container 20. The cover 41 may be a cap that generally seals off the top of the inner cavity 22 and of the annular chamber 24. A passage 41A may be defined in the cover 41. The passage 41A may be in the form of a pipe upon which is mounted a fan 42. The passage 41A may be centrally located as a possibility. As shown, the fan 42 is located inside a housing 43. In the illustrated embodiment, the fan 42 is a centrifugal fan driven by a motor 42A. The housing 43 may therefore have a tangential outlet 43A, or like outlet. Other types of fans may be used, including axial fans. With the cover 41 mounted atop the inner cavity 22, an operation of the fan 42 causes a depression in the space above the liquid line. In an embodiment, the fan assembly 40 is option and may be absent.

As the liquid in the apparatus 10 may boil, some containment feature may be present, such as a shield 44. The shield 44 may be shaped as an inverted cone as one possibility, but a flat plate among others may also be used. The shield 44 may have a central opening to allow a minimum amount of gas to pass, and/or a peripheral gap may surround the shield 44 to define a larger passage for gas. The presence of the shield 44 may protect the fan 42 from liquids. The shield 44 may be part of the container 20 with the cover 41. However, in an embodiment, the cover 41 and the shield 44 are part of the fan assembly 40 in that they are all assembled together and may be removed as one component. This is an option among others. Although not shown, other attachment components may be present, such as latches, bolts, hooks, seals etc, to clamp the cover 41 to the container 20, and limit air leakage between the cover 41 and the container 20.

Therefore, the inner cavity 22 is filled with a liquid such as water, or in another embodiment, oil. The combustion products are injected via the inlet at the bottom of the inner cavity 22. The gases will flow upwardly, for instance by the assistance of the fan assembly 40. The fan assembly 40 is operated so as to induce convection of the gas through the liquid and out through the outlet 43A. In doing so, the combustion products must pass through the fragmenting members 31 which may slow down their upward progression and/or may break or cause fragmentation of bubbles and therefore induce mixture with the liquid. It is the fragmentation that causes the liquid to capture the combustion products, by fragmenting the bubbles that may carry the combustion products. The capacity of the fan assembly 40 may be related to the diametrical dimensions of the inner cavity 22.

Combustion gases are at a high temperature at the exhaust of combustion. Therefore, in order to enhance the efficiency of the apparatus 10, a heat exchanger system 50 may be provided in order to recuperate heat from the combustion. In an embodiment, the heat exchanger system 50 may be in fluid communication with the annular chamber 24. It may also be said that the annular chamber 24 is part of the heat exchanger system 50. In an embodiment, a heat-transfer fluid circulates in the heat exchanger system 50 and is connected to a heat demand. For instance, the heat-transfer fluid is water and the heat exchanger system 50 is connected to a hot water system. The hot water may be used to heat a facility, or may be directed toward other uses in which hot water is necessitated. The hot water may also be used as a heat-transfer fluid, a phase-change fluid, and this entails that other heat transfer fluids may be used such as glycol, brine, etc. In a variant, the capture liquid in the inner cavity 22 is oil, and therefore the temperature of the oil may be substantially greater than that of the boiling point of water. Consequently, if water is in the heat exchanger system 50, steam may be produced by the heat exchange with the oil.

The heat exchange system 50 may include a plurality of heat exchange pipes 51. The heat exchange pipes 51 may include generally straight pipe portions with the ends curving or bending to be in fluid communication with the annular chamber 24, for liquid to circulate freely between the pipes 51 and the annular chamber 24. The straight pipe portions may therefore be spaced apart from inner wall 21, such that a gap is defined between the straight portions of the heat exchange pipes 51 and the inner wall 21, for container water to circulate around the pipes 51 and enhance heat exchange. Accordingly, the deflector rings 34 are present so as to redirect liquid and gases therein toward the fragmenting members 31. Moreover, while straight pipe portions are shown, other patterns are considered, such as zig-zag, coils, etc, to increase the surface area of the pipes 51 inside the inner cavity 22. The heat-transfer fluid in the heat exchange system 50 may be strictly in heat exchange relation with the liquid and gases in the inner cavity 22, i.e., they do not mix. The spacing of the pipes 51 from the inner wall 21 increases the exposure of the pipes to the capture liquid, for favoring heat exchanges.

Deflectors 52 may be present in the annular chamber 24 as part of the heat exchanger system 50. The deflectors 52 may be present in order to cause some movement in the liquid circulating in the annular chamber 24, as the heat-transfer fluid in the chamber 24 absorbs heat from the liquid in the inner cavity 22. The arrangement shown of the annular chamber 24 and heat exchange pipes 51 increases the heat exchange surface by which the heat transfer liquid may absorb heat from the fluid in the inner cavity 22. Other configurations are considered, including having fins on the inner wall 21 instead of the heat exchange pipes 51. Moreover, depending on the necessity to remove heat, the annular chamber 24 may be optional.

As part of the heat exchanger system 50, an expansion tank 53 may be located at a top of the annular chamber 24. The expansion tank 53 is present in order to form a buffer against temperature and/or pressure spikes resulting from the heating of the liquid in the annular chamber 24. Alternatively, or additionally, a pressure-relief valve or equivalent device may be present. Outlet(s) 54 may be located in a bottom of the annular chamber 24 for the outlet of heated liquid. The outlets 54 may be located at other locations as well to collect the heat-transfer liquid or fluid having reclaimed heat from the liquid in the inner cavity 22. For example, if steam exits the heat exchanger system 50, the outlets 54 may be at a top of the annular chamber 24 or of the heat exchange pipes 51. The expansion tank 53 may be an atmospheric tank.

A collection basin 60, or tank, reservoir, collector, etc may be in fluid communication with the inner cavity 22. The collection basin 60 is optional in that an outlet of the inner cavity 22 may simply be provided in the bottom plate 25 to exhaust viscous substances accumulating in the bottom of the inner cavity 22. The outlet may be connected to a pipe network, drain, etc, that removes the waste from the inner cavity 22. Referring to FIG. 8, the collection basin 60 may also be connected to the inner wall 21 in fluid communication, by way of piping 61. The piping 61 may not necessarily be connected to the collection basin 60, so long as it can drain fluid from the inner cavity 22. The end of the piping 61 may be connected to the inner wall 21 at a certain height, so as to be in fluid communication with the liquid in the inner cavity 22, i.e., above an anticipated level of the viscuous substance at the bottom of the inner cavity 22. A valve 62 may also be present in the piping 61. The valve 62 may be automatically operated, such as by a controller with a processor operating the various components of the apparatus 10. For example, the valve 62 may be a solenoid valve.

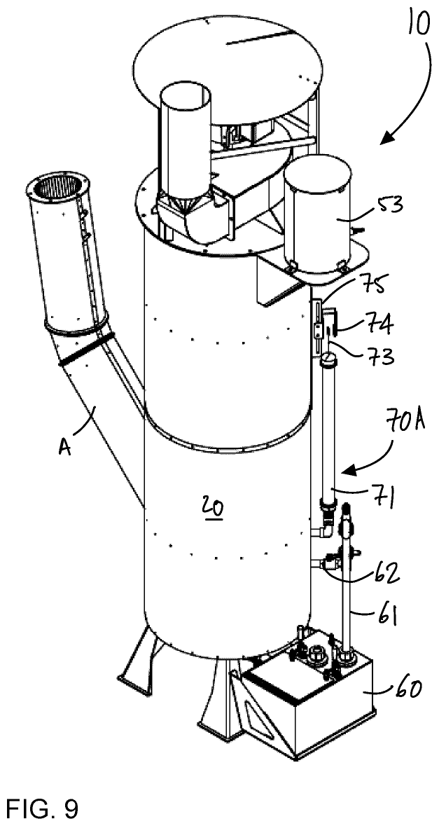

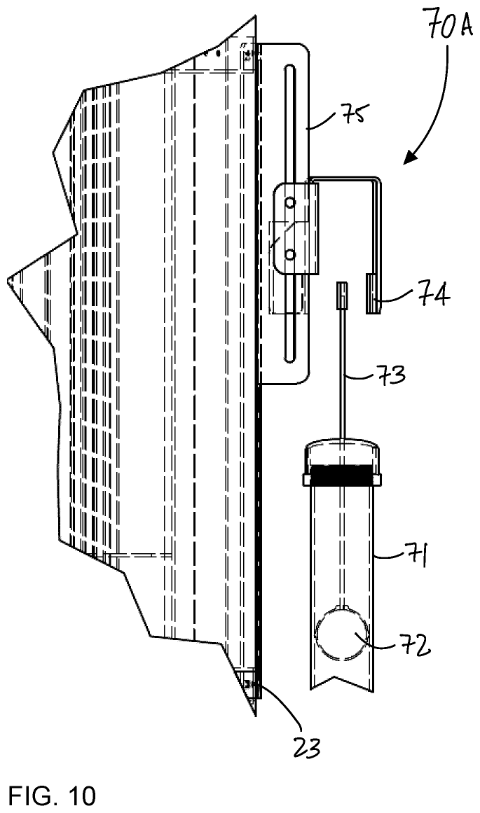

Referring to FIGS. 9 and 10, a liquid level controller device 70A may be present. The liquid level controller device 70A may be connected to a controller to produce signals indicative of a liquid level in the inner cavity 22. In an embodiment, the liquid level controller device 70A has a cylinder 71 that is in fluid communication with the inner cavity 22. The cylinder 71 is connected to the inner cavity 22 at a level below a desired liquid level of the inner cavity 22. For example, the cylinder 71 is connected to the inner cavity 22 below a lowest one of the fragmenting members 31. The cylinder 71 may be an open-ended tube, e.g., atmospheric, with a floating member 72 therein. A level indicator 73 is connected to the floating member 72. By the shown arrangement, the level of liquid in the cylinder 71 may be the same as the liquid level in the inner cavity 22.

The liquid level controller device 70A may further include one or more sensors or probes 74, in line with the level indicator 73, such that the sensor(s) 74 may detect the presence or absence of the level indicator 73. The sensor(s) 74 may be on an adjustment bracket 75, to adjust its height, for instance in a calibration step. The adjustment bracket 75 may be a lockable translation joint, for example. The arrangement of the liquid level controller device 70A is one among others to allow a monitoring of the level of liquid in the inner cavity 22. Level probes are another option, as are infrared sensors, strain gauges to measure a weight of the container 20.

In operation, the liquid level controller device 70A is connected to the controller 70, which in turn may control valves to liquid feed or outlet from the apparatus 10. The liquid level controller device 70A is adjusted to inject liquid when the liquid reaches a low limit of its level in the inner cavity 22, or to outlet liquid when the liquid reaches a high limit of its level in the inner cavity 22. The outlet of liquid may be by actuation of the valve 62 for example, with the inlet of liquid (e.g., water) may be done via a valve for the sprinklers 28, for example.

A method for capturing combustion gases in a liquid, for instance with the apparatus 10, may include one or more of the following steps: injecting combustion gases in a liquid; inducing a fragmentation of the combustion by passing through at least one fragmentation member to capture of the combustion gases by the liquid; discharging the liquid having captured the combustion gases; inducing the fragmentation of the combustion includes causing a pressure differential at a top of a liquid line; recuperating heat from the liquid by heat exchange with a heat-transfer fluid; collecting a viscous substance settled from the liquid.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. (canceled)

2. The apparatus according to claim 30, wherein a plurality of the fragmentation member are located one on top of another.

3. The apparatus according to claim 30, wherein the at least one fragmentation member is a plate with holes.

4. The apparatus according to claim 3, wherein the holes have a surface ranging between 0.0122 in² and 0.790 in², inclusively.

5. The apparatus according to claim 3, wherein the holes have a surface of at most 3.14 in².

6. The apparatus according to claim 3, wherein the plates are separated from an inner wall defining the inner cavity by an annular gap.

7. The apparatus according to claim 6, wherein heat exchanger pipes are in the annular gap.

8. The apparatus according to claim 7, including deflector rings in the annular gap, between the heat exchanger pipes and the inner wall.

9. The apparatus according to claim 8, including rims interfacing the heat exchange pipes to the deflector rings.

10. The apparatus according to claim 8, wherein the deflector rings are axially offset from the plates in a vertical direction.

11. The apparatus according to claim 3, further including a structure interconnecting the plates, the structure and the plates being removable from the container as an assembly.

12. The apparatus according to claim 30, wherein a heat exchange system is connected to the container for heat exchange between a heat-transfer fluid in the heat exchange system and the liquid in the container.

13. The apparatus according to claim 12, wherein the heat exchange system includes an annular chamber surrounding the container.

14. The apparatus according to claim 12, wherein the heat exchange system includes heat exchanger pipes extending into the inner cavity.

15. The apparatus according to claim 30, wherein the container is an upstanding elongated container.

16.-18. (canceled)

19. The apparatus according to claim 18, wherein a fan assembly is located on the cover and is configured to cause a negative pressure differential at a top of a liquid line in the container.

20. The apparatus according to claim 18, including a shield between the fan assembly and the inner cavity.

21. The apparatus according to claim 20, wherein the shield is an inverted cone.

22. The apparatus according to claim 30, including a liquid level controller device for monitoring a level of liquid in the apparatus.

23. The apparatus according to claim 22, wherein the liquid level controller device is connected to liquid inlet and outlet of the container to adjust a level of the liquid in the container.

24.-29. (canceled)

30. An apparatus for capturing pollutants in a gas comprising:
a container defining an inner cavity configured for holding a liquid, and an exhaust end for exhausting gas;
an inlet in fluid communication with a lower portion of the inner cavity, and adapted to receive an injection of a gas;
at least one fragmentation member located in the inner cavity downstream of the inlet and upstream of the exhaust end, the fragmentation member configured to be immersed in the liquid of the container, to induce a fragmentation of the gas passing therethough for capture of the pollutants in the gas by the liquid.
